(19) United States
(12) Patent Application Publication
(10) Pub. No.: US 2026/0016695 A1
(43) Pub. Date: Jan. 15, 2026

(54) PROJECTION SYSTEM AND ELECTRONIC DEVICE

(71) Applicant: ams-OSRAM International GmbH, Regensburg (DE)

(72) Inventors: Joerg Erich SORG, Regensburg (DE); Stefan MORGOTT, Pentling (DE); Peter BRICK, Regensburg (DE)

(21) Appl. No.: 18/994,071

(22) PCT Filed: Aug. 8, 2023
(86) PCT No.: PCT/EP2023/071965

§ 371 Date: Jan. 14, 2025

(30) Foreign Application Priority Data
Aug. 9, 2022 (DE) 10 2022 120 047.7

(51) Int. Cl. G02B 27/01

(52) U.S. Cl. CPC G02B 27/0172

(57) ABSTRACT

A projection system includes a first laser device configured to emit electromagnetic radiation having a first polarization state, a second laser device configured to emit electromagnetic radiation having a second polarization state, and a coupling device configured to superimpose the radiation emitted by the first laser device with the radiation emitted by the second laser device. The system includes an imaging device including an array of individually controllable digital micromirrors. The imaging device is configured to modulate the radiation emitted by the first laser device and the radiation emitted by the second laser device, wherein first modulated radiation and second modulated radiation are generated. The system includes a birefringent plate configured to spatially separate the first modulated radiation and the second modulated radiation, and a control device that actuates the first laser device and the second laser device and is configured to operate the second laser device.

### CROSS-REFERENCE TO RELATED APPLICATIONS

This application is a US National Stage application, filed under 35 U.S.C. § 371, of International Application PCT/EP2023/071965, filed on Aug. 8, 2023, and claims priority to German application 10 2022 120 047.7, filed on Aug. 9, 2022, the entirety of the above listed applications is incorporated herein by reference.

### TECHNICAL FIELD

Various aspects of this disclosure relate to projection systems.

### BACKGROUND

Projection systems by means of which images or image sequences can be displayed at high speed on a screen, for example data glasses for AR (“augmented reality”), VR (“virtual reality”) applications, are being investigated to a great extent. In general, solutions are sought by means of which compact, rapidly controllable and cost-effective projection systems can be realized.

### SUMMARY

Various embodiments of the present disclosure relate to an improved projection system and an improved electronic device.

According to embodiments, a projection system comprises a first laser device which is configured to emit electromagnetic radiation having a first polarization state, a second laser device which is configured to emit electromagnetic radiation having a second polarization state, and a coupling device. The coupling device is configured to superimpose the electromagnetic radiation emitted by the first laser device with electromagnetic radiation emitted by the second laser device. The projection system furthermore comprises an imaging device which comprises an arrangement of a multiplicity of individually controllable digital micromirrors, wherein the imaging device is configured to modulate the electromagnetic radiation emitted by the first laser device and the electromagnetic radiation emitted by the second laser device, wherein first modulated radiation and second modulated radiation are generated. The projection system furthermore comprises a birefringent plate which is configured to spatially separate the first modulated radiation and the second modulated radiation, and a control device which actuates the first laser device and the second laser device and is configured to operate the second laser device with a temporal offset with respect to the first laser device within an image frame. As a result, the resolution of the projection system can be increased without-apart from the components of the imaging device-mechanical parts having to be moved. For example, the resolution of the projection system can be doubled without increasing the number of micromirrors.

The projection system furthermore contains a screen on which an image generated by the first and the second modulated radiation can be displayed.

For example, a reflective beam shaping element can be arranged between the birefringent plate and the screen. The reflective beam shaping element may be configured to increase or reduce the generated image, that is to say the superposition of a first image which is generated by the first modulated radiation and of a second image which is generated by the second modulated radiation. As a result, a distance between the image generated by the first modulated radiation and the image generated by the second modulated radiation may be set. For example, the reflective beam shaping element may be embodied as a convex mirror or as a concave mirror.

For example, the first laser device and the second laser device may each contain a plurality of laser elements which are configured to emit electromagnetic radiation with a respectively different wavelength. For example, the plurality of laser elements may each emit light of different colors. For example, the colors can be selected depending on the color space. According to embodiments, one of the laser elements can emit red light, another laser element can emit blue light and a further laser element can emit green light. Other colors are possible.

According to embodiments, a plurality of laser elements may be arranged along a first arrangement direction. According to further embodiments, further laser elements may be arranged along a second arrangement direction which is perpendicular to the first arrangement direction.

For example, the coupling device may be configured to respectively superimpose electromagnetic radiation emitted by the first laser device with electromagnetic radiation emitted by the second laser device, wherein the superimposed radiation has approximately the same wavelength. More precisely, light of the same color is respectively superimposed by the coupling device. For example, in this context, the term “approximately the same wavelength” may mean that the respectively superimposed wavelengths can differ by a maximum of 50 nm.

According to embodiments, an electronic device comprises the projection system according to one of the preceding claims.

The electronic device can be embodied, for example, as AR or VR data glasses.

### BRIEF DESCRIPTION OF THE DRAWINGS

The accompanying drawings serve to understand embodiments of the invention. The drawings illustrate exemplary embodiments and together with the description serve to explain them. Further embodiments and numerous of the intended advantages emerge directly from the following detailed description. The elements and structures shown in the drawings are not necessarily illustrated true to scale with respect to one another. Identical reference signs refer to identical or mutually corresponding elements and structures.

FIG. 1A shows a schematic illustration of a projection system according to embodiments.

FIG. 1B shows a schematic view of a projection system according to further embodiments.

FIG. 2A shows an illustration of a laser device which may be part of a projection system according to embodiments.

FIG. 2B shows an example of a laser arrangement.

FIG. 2C shows a further example of a laser arrangement.

FIG. 2D shows a further example of a laser device.

FIG. 2E shows a further example of a laser device.

FIG. 3A illustrates an electronic device according to embodiments.

FIG. 3B shows an example of an electronic device.

### DESCRIPTION

In the following detailed description, reference is made to the accompanying drawings, which form part of the disclosure and in which specific embodiments are shown for illustrative purposes. In this context, directional terminology such as “top side”, “bottom side”, “front side”, “rear side”, “above”, “on”, “in front of”, “behind”, “front”, “rear”, etc. is referred to the orientation of the figures just described. Since the components of the embodiments can be positioned in different orientations, the directional terminology serves only for explanation and is in no way limiting.

The description of the embodiments is not limiting, since other embodiments also exist and structural or logical changes can be made without deviating from the range defined by the claims. In particular, elements of embodiments described below can be combined with elements of other embodiments described, unless the context indicates otherwise.

The terms “lateral” and “horizontal”, as used in this description, are intended to describe an orientation or orientation which runs substantially parallel to a first surface of a substrate or semiconductor body. This can be, for example, the surface of a wafer or a chip (die).

The horizontal direction may lie, for example, in a plane perpendicular to a growth direction during the growth of layers.

The term “vertical”, as used in this description, is intended to describe an orientation which runs substantially perpendicular to the first surface of a substrate or semiconductor body. The vertical direction may correspond, for example, to a growth direction during the growth of layers.

To the extent that the terms “have”, “contain”, “comprise”, “include” and the like are used here, these are open terms which indicate the presence of said elements or features, but do not exclude the presence of further elements or features. The indefinite articles and the specific articles comprise both the plural and the singular, unless the context clearly indicates otherwise.

The projection system described below comprises a first and a second laser device. The laser device described may comprise a multiplicity of laser arrangements which may in turn contain individual laser elements.

The laser elements may be semiconductor laser elements which are embodied as thin-film lasers. For example, the laser elements can be embodied as edge emitters or as surface-emitting lasers (VCSEL, “vertical cavity surface emitting laser”). The laser arrangement described can be embodied, for example, as a multiridge laser having a plurality of light-emitting ridges. For example, one or more laser elements can be arranged in each case in different ridges. Laser elements arranged in different ridges may be configured, for example, to emit electromagnetic radiation with respectively different wavelengths (ranges) or colors. According to further embodiments, the laser arrangements can also comprise individual edge-emitting laser elements or laser ridges which are arranged on a common carrier element.

In general, different semiconductor laser elements which are part of a laser device can each emit light of different colors. Furthermore, different semiconductor laser elements which are part of a laser device can each emit different wavelengths within one color. For example, the wavelengths can be slightly shifted with respect to one another, for example by less than 50 nm. In this way, speckles can be reduced. According to further configurations, different semiconductor laser elements which are part of a laser device can emit light of the same color but with different intensities. This can be achieved, for example, by a different reflectivity of the respectively used resonator mirrors. According to further embodiments, this can be achieved by a different resonator length when edge-emitting lasers are used. In this way, a larger dynamic range of the projection system can be realized.

As will also be described, the first and the second laser device each emit different polarization directions. Apart from the different polarization direction of the respectively emitted electromagnetic radiation, the first and the second laser device can be identical to one another. The individual laser elements which are part of the first and the second laser devices can be identical to one another-apart from the polarization state of the respectively emitted electromagnetic radiation. Thus, a colinear coupling of two polarized light or laser sources can take place. For example, the lasers may be operated sequentially alternately.

According to further embodiments, for example, a laser device may comprise an array of laser elements, for example more than 5×5 or more than 10×10 laser elements. For example, in this case, the individual laser elements may be embodied as surface-emitting semiconductor laser elements (VCSEL).

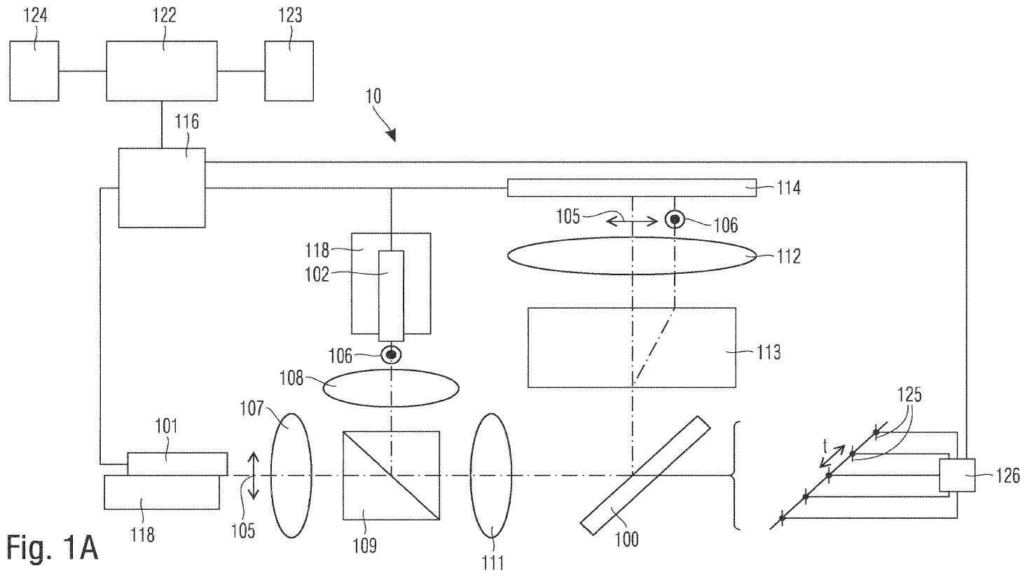

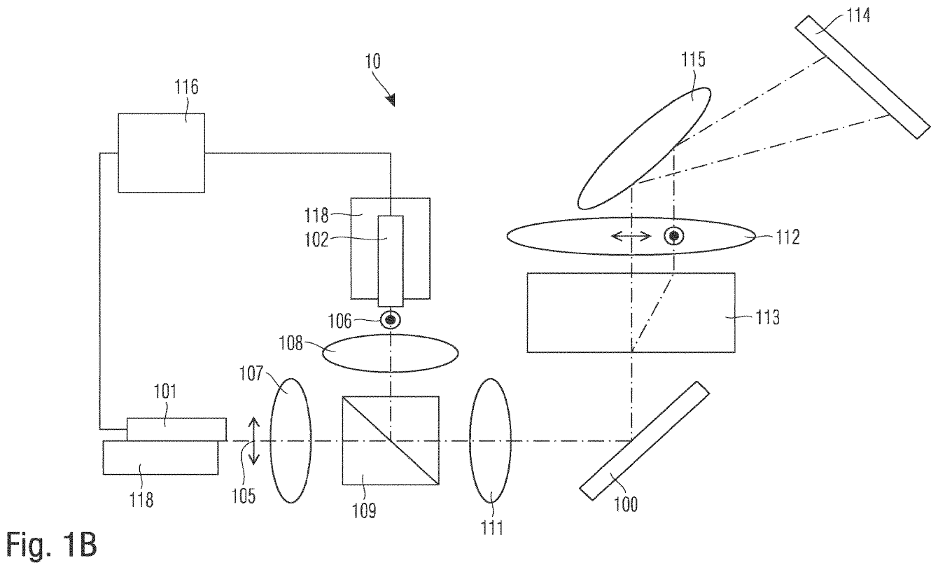

FIG. 1A shows a schematic illustration of a projection system 10 according to embodiments. The projection system 10 comprises a first laser device 101 and a second laser device 102.

The first laser device 101 is configured to emit electromagnetic radiation having a first polarization state 105. The second laser device is configured to emit electromagnetic radiation having a second polarization state 106. For example, the first polarization state can be a linear polarization state in a first direction and the second polarization state is a second polarization direction which is perpendicular to the first polarization direction. However, according to further embodiments, it is also conceivable for the first polarization state to correspond to a first linear polarization direction and for the second polarization state to correspond to a circular polarization direction or vice versa.

The projection system furthermore comprises a coupling device 109 which is configured to coaxially superimpose the emitted electromagnetic radiation which has been emitted by the first laser device 101 with the electromagnetic radiation which has been emitted by the second laser device 102. The combined electromagnetic radiation is used for the illumination of an imaging device 100. As will be explained below, the first and the second laser device 101, 102 may each contain a plurality of laser elements which are configured to emit electromagnetic radiation with respectively different wavelengths. For example, the respective combined light of a wavelength range, for example of a color, is used for the illumination of the imaging device 100.

The imaging device 100 can have, for example, an arrangement of a multiplicity of individually controllable digital micromirrors 125. In this case, the micromirrors 125 may be movable, for example, by a control device 126. The micromirrors 125 may be switched between two positions, for example. In a first position, the incident electromagnetic radiation is reflected in the direction of the further components of the projection system 10. In a further position, incident electromagnetic radiation is reflected in a different direction. In this way, each of the micromirrors 125 constitutes an image element which can be set to “On” or “Off” by actuation of the control device 126. The imaging device 100 is also referred to as DLP (“digital light processing”) imager or engine. The micromirrors 125 have very short switching times. As a result, very rapid image change rates, for example over 200 Hz, for example 240 Hz, can be achieved.

As a result, the electromagnetic radiation emitted by the first laser device 101 and the electromagnetic radiation emitted by the second laser device 102 may be modulated by the imaging device 100. In this case, first modulated radiation having a first polarization state and second modulated radiation having a second polarization state are generated. The first and second modulated radiation then enter a birefringent plate 113. The birefringent plate 113 is suitable for spatially deflecting electromagnetic radiation differently in accordance with the polarization state. In this way, the first modulated radiation and the second modulated radiation may be spatially separated. The projection system 10 can furthermore comprise, for example, a screen 114 or another display device on which an image generated by the first and the second modulated radiation can be displayed. There is a slight spatial offset between the image generated by the first modulated radiation and the image generated by the second modulated radiation.

The optical projection system 10 can comprise numerous optical elements for beam expansion and beam shaping, for example corresponding lenses. For example, a first optical element 107 for collimating the electromagnetic radiation which has been emitted by the first laser device 101 may be arranged between the first laser device 101 and the coupling device 109.

Furthermore, a second optical element 108 for collimating the electromagnetic radiation which has been emitted by the second laser device 102 may be arranged between the second laser device 102 and the coupling device 109. In addition, an optical element 111 which acts as transmission optics may be arranged between the imaging device 100 and the coupling device 109. Furthermore, an optical element 112 which acts as projection optics may be arranged between the birefringent plate 113 and the screen 114. Of course, further optical elements may be provided at suitable positions.

The birefringent plate 113 is made of a birefringent material. The birefringent plate 113 is arranged in such a way that the first and second modulated electromagnetic radiation are spatially separated from one another with respectively different polarization states. In this way, two laterally offset images may be generated in the projection plane. The offset of the images may correspond, for example, to half a pixel size. According to further embodiments, the offset may also correspond to a pixel size or an integer multiple of a pixel size. The term “pixel size” relates here to the pixel size in the image, for example on the screen 114. The pixel size depends on the distance between adjacent micromirrors 125 of the imaging device 100, for example the distance t between the centers of adjacent micromirrors. Furthermore, the pixel size in the image depends on the imaging properties of the optics.

According to embodiments, the projection system 10 furthermore comprises a control device 116. The control device 116 actuates the first laser device 101 and the second laser device 102. The control device 116 is configured to operate the first laser device with a temporal offset with respect to the first laser device within an image frame. More precisely, the control device 116 may be configured to operate one or more laser elements 119ᵢ of the first laser device 101 at a time t1 and to respectively operate one or more associated laser elements 119ᵢ of the second laser device 102 at a time t1+Δt, wherein Δt is less than 1/f and f denotes the frame rate of the projection system. For example, the first laser device 101 and the second laser device 102 can be constructed identically to one another. In this case, respectively mutually corresponding laser elements are controlled by the control device 116 in the manner described. According to embodiments, laser elements of the first and of the second laser device 101, 102, which respectively emit electromagnetic radiation with the same wavelength, may also be driven by the control device 116. In general, each laser element of the first and of the second laser device 101, 102 may be actuated individually by the control device 116.

For example, individual laser elements of a color with a slightly shifted wavelength may be actuated simultaneously by the control device 16, with the result that a spectral emission width is increased and the formation of speckles is suppressed. For example, a respectively different number of laser elements can also be actuated in order to control the brightness of the image. According to further embodiments, different laser elements with different emission intensities may also be actuated depending on the brightness to be achieved.

The control device 116 may furthermore be configured to operate the micromirrors 125 of the imaging device 100, for example via the control device 126. For example, the actuation of the individual micromirrors 125 can take place in accordance with the image information to be imaged.

According to embodiments, the projection system 10 can furthermore be provided with a processor 122 for processing and generating control signals. The processor 122 can be connected to a memory device 124, for example. For example, image data can be stored in the memory device 124. According to further embodiments, the processor may be connected to a communication device 123. The communication device 123 may represent an interface for data communication, for example. The communication device 123 may receive image data, for example. These are then processed further by the processor. The control device 116 may receive the image data, for example, and generate control signals for controlling the first laser device and the second laser device 101, 102 and also the micromirrors 125 of the imaging device 100.

As has been described, in this way the high possible clock frequency of the micromirrors may be used to sequentially generate a plurality of images within a frame. These sequentially described images are generated with a slight lateral offset. In this way, an image may be generated with a resolution which corresponds to a multiple of the pixel resolution. Since the human eye is relatively sluggish, the temporal offset of the images is not perceived by the human eye. By virtue of the fact that the offset is generated by the temporally successive actuation of the first laser device and the second laser device, the basic principle may be realized without the associated optical components having to be moved at high speed. The projection system 10 may be used, for example, in so-called NTE (“near-to-eye”) applications since an increased resolution can be achieved without noises being generated by the high-frequency movement of optical components.

By means of a suitable synchronization of the first and the second laser device 101, 102 and also of the imaging device 100, for example in the control devices 116, 126, a plurality of images may thus be generated within a temporal frame. Since the imaging device 100 may be operated at a very high frequency as described above, it is possible to generate a plurality of slightly offset images by sequentially switching on different polarization states within a frame. By virtue of the superposition of the respectively slightly offset individual images within a frame, it is possible to generate images which have a substantially higher resolution than the imaging device 100 itself.

The electromagnetic radiation emitted by the individual laser elements may be collimated well on account of the small size and the directional emission of the laser elements. In this way, the imaging device may be illuminated exactly with a collimated beam. By means of a suitable synchronization of the first and the second laser devices 101, 102 and the imaging device 100, a plurality of images can thus be generated within a temporal frame without additional use of moving parts.

FIG. 1B shows a view of the projection system 10 according to further embodiments. The projection system from FIG. 1B has similar components to the projection system in FIG. 1A. Differing from FIG. 1A, a reflective beam shaping element 115 is additionally arranged between the screen 114 and the birefringent plate 113. The reflective beam shaping element 115 may increase or reduce, for example, the image which results from the superposition of the first image which is generated by the first modulated radiation and of the second image which is generated by the second modulated radiation. As a result, the spatial distance of the modulated beams can be further set. For example, the distance can be increased or reduced. In this way, the lateral offset of the individual images can be adapted as required.

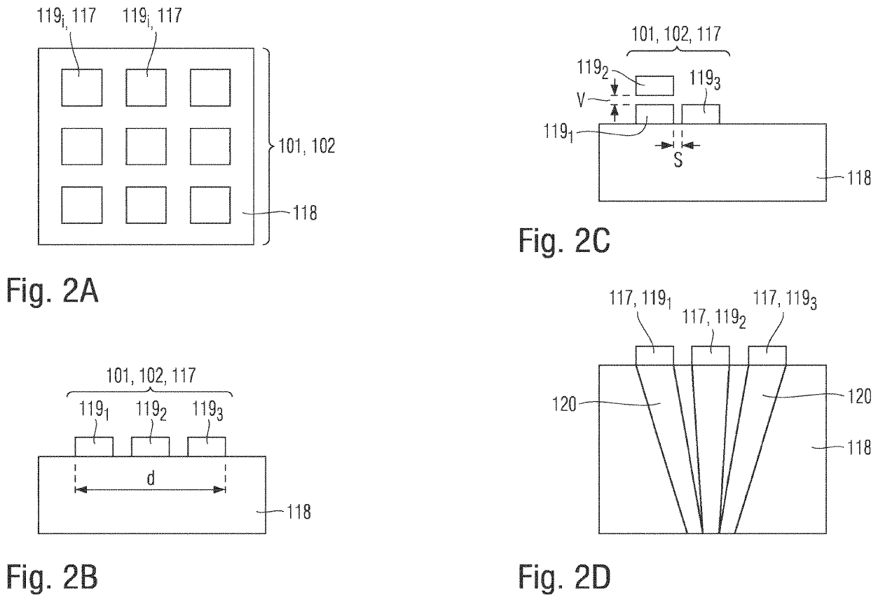

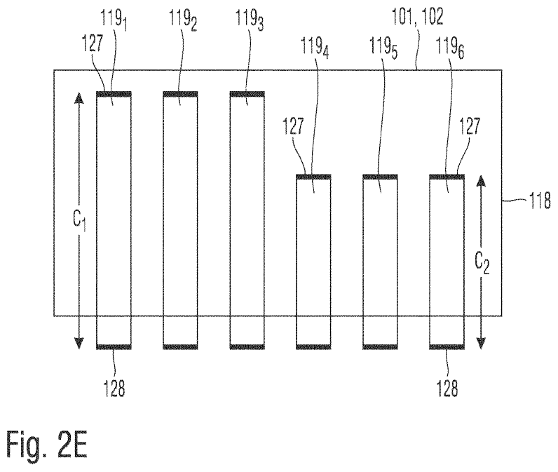

FIG. 2A shows a schematic view of a first or a second laser device 101, 102. A multiplicity of laser arrangements 117 can be attached, for example, to a suitable mount 118. A laser arrangement 117 can, for example, each contain a plurality of laser elements 119i, . . . 119ₙ. For example, the individual laser elements 1191, . . . 119n may each emit electromagnetic radiation of different wavelengths. For example, the individual laser elements 119i may be embodied as edge-emitting laser elements. In this case, they can be arranged “linearly”, that is to say along a horizontal arrangement direction with respect to a surface of the mount 118, as illustrated, for example, in FIG. 2B. According to embodiments, as shown in FIG. 2C, they can additionally be arranged along a vertical arrangement direction.

According to further embodiments, a multiplicity of laser elements 119i can be attached to the mount 118. The laser elements 119ᵢ may be embodied as surface-emitting laser elements. In this case, they can be arranged, for example, along two different horizontal arrangement directions with respect to a surface of the holder 118. For example, in this case, an emission can take place via a surface which is parallel to the illustrated drawing plane.

FIG. 2B shows a schematic view of a laser arrangement 117 or laser device 101, 102. For example, a laser arrangement 117 or laser device 101, 102 can contain three edge-emitting laser elements 119₁, 119₂, 119₃, one of which emits light with blue wavelength, a further light with green wavelength and a third laser element emits light with red wavelength. However, the laser arrangements 117 can each also be constructed differently and also contain only a single laser element. In the case of the laser elements 119ᵢ illustrated in FIG. 2B, an emission takes place by a surface which is parallel to the illustrated drawing plane.

The three laser elements 119₁, 119₂, 119₃ are arranged, for example, above a suitable mount 118. The distance d between the outermost edge of the two outer laser elements can be, for example, greater than approximately 300 μm. Furthermore, a distance between the two outer emission points may be less than approximately 300 μm. For example, the laser elements can be arranged such that a distance s between the inner emission points is less than 20 μm. As illustrated in FIG. 2B, the individual laser elements can be arranged along a single direction.

According to further embodiments, the laser elements 119i can also be packed more densely. For example, distances between the emission points can be less than 100 μm or else less than 50 μm or less than 20 μm.

As illustrated in FIG. 2C, the laser elements can be arranged along two different arrangement directions. For example, two laser elements of a laser arrangement 117 can be arranged in a horizontal direction with respect to one another and a third laser element 119₂ is arranged above the first laser element 119₁, i.e. along a vertical arrangement direction. In this case, for example, the horizontal distance s between the two outer emission points can be less than 100 μm. A vertical distance between the outer emission points v may be less than 15 μm. According to embodiments, in order to produce the laser arrangement illustrated in FIG. 2C, semiconductor chips which contain the corresponding laser elements can be stacked one above the other. This can take place, for example, at the wafer level or at the chip level.

As illustrated in FIG. 2D, the individual laser elements 119₁, 119₂, 119₃ or laser arrangements 117 can each be arranged at relatively large distances. In this case, the emitted electromagnetic radiation can be combined via waveguides 120.

FIG. 2E shows a schematic view of a first or second laser device 101, 102 which contains a plurality of laser elements 119₁, 119₆ which are embodied as edge-emitting semiconductor lasers. For example, laser elements 119₁ and 119₄ emit electromagnetic radiation of the same color, for example red light. Furthermore, laser elements 119₂ and 119₅ emit electromagnetic radiation of the same color, for example blue light. Furthermore, laser elements 119₃ and 119₆ emit electromagnetic radiation of the same color, for example green light. Furthermore, the laser elements 119₁, 119₂, 119₃ emit light with a greater intensity than the laser elements 119₄, 119₅ and 119₆. As illustrated in FIG. 2E, this can take place by correspondingly setting the length c₁, c₂ of the optical resonators. In this way, a larger dynamic range of the projection system may be realized as described above.

According to embodiments, alternatively or additionally, the reflectivity of the first resonator mirrors 127 can be set such that the reflectivity of the first resonator mirrors 127 of the laser elements 119₁, 119₂, 119₃ is greater than the reflectivity of the first resonator mirrors 127 of the respective laser elements 119₄, 119₅, 119₆. Furthermore, alternatively or additionally, the reflectivity of the second resonator mirrors 128 can be set such that the reflectivity of the second resonator mirrors 128 of the laser elements 119₁, 119₂, 119₃ is smaller than the reflectivity of the second resonator mirrors 128 of the respective laser elements 119₄, 119₅, 119₆.

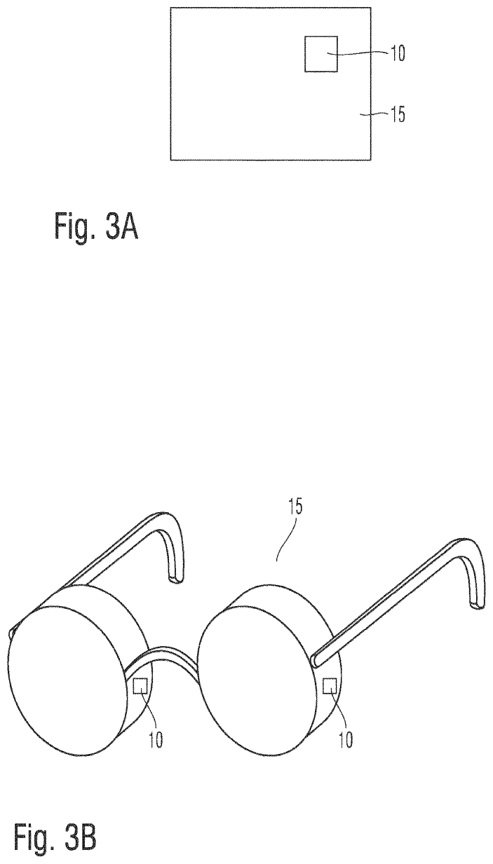

FIG. 3A shows a schematic view of an electronic device 15. The electronic device 15 comprises the projection device 10. The projection system is suitable, in particular, for near-eye projection. Accordingly, the electronic device can be embodied as data glasses, as illustrated in FIG. 3B.

Although specific embodiments have been illustrated and described herein, persons skilled in the art will recognize that the specific embodiments shown and described can be replaced by a multiplicity of alternative and/or equivalent configurations without departing from the present disclosure. The application is intended to cover any adaptations or variations of the specific embodiments discussed herein.

### LIST OF REFERENCES

10 projection system
15 electronic device
100 imaging device
101 first laser device
102 second laser device
105 first polarization state
106 second polarization state
107 first optical element
108 second optical element
109 coupling device
111 optical element
112 optical element
113 birefringent plate
114 screen
115 reflective beam shaping element
116 control device
117 laser arrangement
118 mount
119₁ . . . 119ₙ laser element
120 waveguide
122 processor
123 communication device
124 memory device
125 micromirror
126 control device
127 first resonator mirror
128 second resonator mirror

What is claimed is:

1. A projection system comprising:
a first laser device configured to emit electromagnetic radiation having a first polarization state;
a second laser device configured to emit electromagnetic radiation having a second polarization state;
a coupling device configured to superimpose the electromagnetic radiation emitted by the first laser device with the electromagnetic radiation emitted by the second laser device;
an imaging device comprising an array of a plurality of individually controllable digital micromirrors, wherein the imaging device is configured to modulate the electromagnetic radiation emitted by the first laser device and the electromagnetic radiation emitted by the second laser device, wherein first modulated radiation and second modulated radiation are generated,
and a birefringent plate configured to spatially separate the first modulated radiation and the second modulated radiation, further comprising
a control device that actuates the first laser device and the second laser device and is configured to operate the second laser device with a temporal offset from the first laser device within an image frame.

2. The projection system according to claim 1, further comprising a screen on which an image generated by the first and the second modulated radiation is displayable.

3. The projection system according to claim 2, further comprising a reflective beam shaping element between the birefringent plate and the screen.

4. The projection system according to claim 3, wherein the reflective beam shaping element is configured to enlarge or reduce a synthesized image resulting from a superimposition of the image generated by the first modulated radiation and the image generated by the second modulated radiation.

5. The projection system according to claim 1, wherein the first laser device and the second laser device each include a plurality of laser elements configured to emit electromagnetic radiation having different wavelengths corresponding to different colors, respectively.

6. The projection system according to claim 5, wherein the laser elements are configured as edge emitters and a plurality of laser elements are arranged along a first arrangement direction.

7. The projection system according to claim 6, wherein further laser elements are arranged along a second arrangement direction perpendicular to the first arrangement direction.

8. The projection system according to claim 5, wherein the first laser device and the second laser device each include a plurality of laser elements configured to emit electromagnetic radiation having different wavelengths corresponding to same colors, respectively.

9. The projection system according to claim 5, wherein the first laser device and the second laser device each include a plurality of laser elements configured to emit electromagnetic radiation having same color and different intensities.

10. The projection system according to claim 5, wherein the coupling device is configured to superimpose electromagnetic radiation emitted by the first laser device with electromagnetic radiation emitted by the second laser device, respectively, the superimposed radiation having the same wavelength.

11. An electronic device comprising the projection system according to claim 1.

12. The electronic device according to claim 11, which is configured as AR or VR data glasses.
